(19) United States
(12) Patent Application Publication
(10) Pub. No.: US 2005/0058138 A1
(43) Pub. Date: Mar. 17, 2005

(54) Communications management system

(76) Inventors: Tim Bucher, Los Altos, CA (US); James A. Savage III, San Jose, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/935,891

(22) Filed: Sep. 8, 2004

Related U.S. Application Data
(60) Provisional application No. 60/502,384, filed on Sep. 12, 2003.

(51) Int. Cl. G06F 15/16

(52) U.S. Cl. 370/395.42; 709/200

(57) ABSTRACT

A communications management system, method and software are provided that are configured to automatically and systematically manage the transmission of identified content subject to, for example, the bandwidth requirements of the identified content, the bandwidth required for transmission of such content, and various attributes of the identified content. The system, method and software may be implemented in various environments such as a single computing device or a network. Yet other embodiments are implemented, either in whole or in part, as a fee based communications management service. In general, the system, method and software are initially concerned with identifying the content to be transferred. Transmission of the content is then managed with reference to various transmission protocols that specify relationships between attributes of the identified content and various communications management actions, so that content possessing particular attributes is handled in accordance with the corresponding specified communications management actions.

### CROSS-REFERENCE TO RELATED APPLICATIONS

This application claims the benefit of U.S. Provisional Application Ser. No. 60/502,384, filed Sep. 12, 2003, which is incorporated herein by reference.

### BACKGROUND OF THE INVENTION

1. Field of the Invention

The present invention relates generally to data communication. More particularly, embodiments of the present invention relate to systems, methods, and software for managing communications between multiple computing environments.

2. Related Technology

Computer networks, and related systems, devices and software are employed in a wide variety of applications by businesses, home-based operations, and other enterprises. Many businesses and home-based operations employ a single small network, such as a local area network (“LAN”). In yet other cases, relatively larger and more geographically dispersed networks, such as wide area networks (“WAN”) for example, are required in order to implement the functionality required by larger businesses and enterprises.

This is particularly true in the case of large national and multinational corporations, for example, that may have any of a number of offices, operating centers, or sites, distributed over a large geographical area, or otherwise partitioned or separated from each other in some way. In cases such as these, it is common for an entity to employ one or more computer networks at each site, so as to facilitate both inter and intra site communications.

Such computers and computer networks are generally configured to communicate with other systems, networks and devices by various types of communications channels. Often, it is desired to communicate with, or by way of, a public communications network such as the Internet. Such communications channels may be implemented in various ways. By way of example, communications channels such as ‘plain old telephone service’ (“POTS”), digital subscriber line (“DSL”), cable, and broadband connections are commonly employed in a variety of applications and environments.

Moreover, each type of communications channel is characterized by a maximum achievable data transfer rate, often referred to as bandwidth. The bandwidth required in a particular environment is often a function of the type and volume of communications anticipated for that environment. Thus, a business enterprise may require a communications channel with a relatively greater bandwidth than would be required, for example, by a home user.

As computers, networks and related systems and devices have proliferated, the volume of communications between and among such systems and devices has correspondingly increased, thereby taxing the capacity of the communications channels through which such communications are transmitted. Moreover, the speed with which communications pass through the communications channel is further degraded in cases where relatively large files, such as audio, video, or graphics files, or applications, are transmitted. This is typically due to the bandwidth limitations inherent in the communications channel.

Such bandwidth limitations implicate a variety of different problems. By way of example, users whose communications channels carry a high level of traffic typically experience effects such as long upload and/or download times. Slow uploads and downloads limit the availability of the communications channel for other transmissions and communications, and also slow the speed with which such other transmissions and communications can be implemented. This problem is of particular concern where a user employs a single telephone line both for telephone service and as a computing environment communications channel, since the telephone line is not available for voice communication during the duration of the upload or download processes.

Moreover, relatively long upload and download times may, in some cases, divert processing resources away from other applications, processes or programs used by the computing system, thereby slowing or otherwise compromising the operation of associated computers and other systems and devices. Further, slow upload and download times are frustrating for users and may discourage users from accessing the Internet or certain websites.

Another concern relates to the growth that is typically experienced in many computing environments over a period of time. In particular, computing environments such as networks tend to grow over time as new users and systems are added. Such growth necessarily contributes to an increase in the load placed on the communications channels employed by the computing environment.

Not only do bandwidth limitations and related problems compromise the functionality and operability of computer, networks and other systems and devices, but such limitations and problems often do not lend themselves to effective solution because users typically lack useful control over the transmission and receipt of content. By way of example, files or other content designated for transmission are typically transmitted according to a default ‘first-in-first-out’ scheme. That is, files are simply transmitted in the order that they are designated for transmission. Accordingly, senders have little control over when, or how, their content will actually be transmitted or how long such transmission will take.

Further, most users are unaware of the particular bandwidth capacity that is available at any given time. Thus, it is difficult for such users to shift their transmission to a more optimum time period. Even if a user decides to send a transmission at off-peak hours, such as midnight when more bandwidth is likely to be available, such a solution is not practical since most users are not inclined, nor may be able, to return to their office during off-peak hours to effect such a transmission.

In similar fashion, users are generally unable to control the receipt of content transmitted from other computing environments. Thus, a large file, or a large volume of files, directed to a particular computing environment may interrupt or disrupt other communications to and/or from the destination computing environment by using a substantial portion of the available communications bandwidth associated with such destination computing environment.

Yet another problem implicated by bandwidth limitations is that users generally are not able to prioritize transmissions, or receipt of electronic materials, in a useful way. Thus, while one user in a computing environment may have a need to quickly transmit or receive a large file, for example, such transmission or receipt may be significantly impaired, if not prevented altogether, by transmissions made, or received, by other users in the computing environment.

Not only do users have limited control, in most instances, over the transmission and receipt of content, but it is generally not practical to increase the characteristic bandwidth of a particular communications channel. Moreover, achievement of an increase in bandwidth through other types of changes to the communications infrastructure may be impractical as well. For a home user, for example, the increase in cost associated with moving from a POTS communication channel to broadband may be prohibitive. Businesses and other enterprises face similar concerns when deciding, for example, whether to upgrade the existing communications channel and/or add another communications channel.

In view of the foregoing problems, and other problems in the art not specifically enumerated herein, what is needed are systems, methods and software that provide for effective management of communications between computing environments. Such systems, methods and software should implement their functionality substantially automatically and should, among other things, permit users to optimize bandwidth utilization and to customize content transmission processes as necessary to suit particular requirements and operating environments.

### BRIEF SUMMARY OF AN EXEMPLARY EMBODIMENT OF THE INVENTION

In general, embodiments of the present invention relate to systems, methods, and software for managing communications between computing environments, such as by optimizing utilization of communications bandwidth.

In one exemplary embodiment of the invention, a communications management system and method are provided that are configured to operate as a fee-based service that automatically and systematically manages the transmission of content between computing environments. In this embodiment, various transmission protocols are defined that specify certain relationships between particular content attributes, and various communication management actions that are to be implemented, by way of a communications manager, with respect to content possessing such attributes.

When the content desired to be transmitted has been identified, the communications management system notes the transmission protocol, or protocols, implicated by the identified content. By accessing the transmission protocols thus identified, the communications management system can determine, and implement, the specified action with respect to the identified content. This functionality is employed in both content upload and download processes.

In this way, customized, automatic and systematic management of content transmission according to user-defined protocols is afforded. Moreover, embodiments of the invention also provide for optimized utilization of communications bandwidth through management of content transmission. These and other aspects of embodiments of the present invention will become more fully apparent from the following description and appended claims.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a schematic diagram that illustrates aspects of an exemplary communications management system;

FIG. 2A is a block diagram illustrating aspects of an exemplary transmission protocol structure;

FIG. 2B is a block diagram illustrating aspects of an alternative transmission protocol structure;

FIG. 3 is a schematic diagram that illustrates exemplary content attribute information such as may be employed to guide the operation of the communications management system;

FIG. 4 is a flow diagram that illustrates aspects of an exemplary implementation of a communications management process;

FIG. 5 is a flow diagram that illustrates aspects of another exemplary implementation of a communications management process wherein content transmission is controlled by reference to bandwidth requirement and bandwidth availability;

FIG. 6 is a schematic diagram that illustrates aspects of another exemplary implementation of a communications management process such as may be implemented by way of a network appliance;

FIG. 7 is a schematic diagram of an exemplary operating environment wherein the communications management system is not associated with any particular computing environment;

FIG. 8 is a schematic diagram of an alternative operating environment wherein the communications management system resides in a particular computing environment;

FIG. 9 is a schematic diagram of yet another operating environment wherein the communications management system manages communications between a client network and a public communications network; and

FIG. 10 is a schematic diagram of an operating environment wherein aspects of the communications management system functionality are implemented as part of a communications management service.

FIG. 11 is a schematic diagram of a network by which data associated with network appliances is made available to remote users and remote network appliances.

### DETAILED DESCRIPTION OF SELECTED EMBODIMENTS OF THE INVENTION

Reference will now be made to the drawings to describe various exemplary embodiments of the invention. It is to be understood that the drawings are diagrammatic and schematic representations of such exemplary embodiments, and are not limiting of the scope of the present invention in any way, nor are they necessarily drawn to scale.

Embodiments of the invention relate generally to systems, methods, and software for managing communications between computing environments. More particularly, embodiments of the present invention relate to systems, methods, and software for facilitating management of content transmission between computing environments. The content management solution is implemented so that the transmission of content can be automatically and systematically implemented. As disclosed herein, such implementation is achieved through the use of various user defined transmission protocols that specify relationships between the content to be transmitted and various content transmission actions. Among other things, this functionality permits optimized utilization of communications bandwidth.

I. Exemplary Structural Implementations

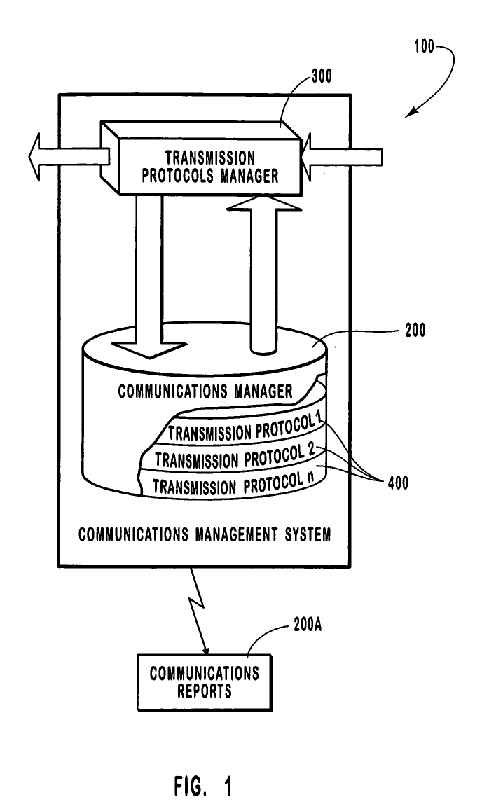

Directing attention now to FIG. 1, various details are provided concerning aspects of an exemplary embodiment of a communications management system, denoted generally at 100, for use in controlling, and otherwise managing, the transmission of content between computing environments. Note that, as used herein, ‘content’ includes, among other things, software, data, information, electronic mail and any other electronic materials, however such may be embodied or expressed, in conjunction with which it may be useful or desirable to employ embodiments of the invention.

Further, it should be noted that ‘transmission,’ as such term is used herein, may relate to any desired point of reference so that, for example, content received at a given destination can also be considered to comprise content transmitted from some source. By way of example, content downloaded from a website to an appliance, for subsequent distribution to network devices with which the appliance is associated, comprises a transmission of content from the website to the appliance, as well as a transmission of content from the appliance to the network devices. Thus, a ‘transmission’ may include an initial or first transmission of content, an intermediate transmission of content between two points prior to the content reaching a final destination, transmission of the content to its final destination, an upload of content, and/or a download of content.

With respect to the implementation of content transmission, transfer or transferal, as it may sometimes be referred to herein, it should also be noted that embodiments of the invention are not limited to any particular system, method, device, software, and/or communications channel in conjunction with which such a transmission of content may be effected. Thus, the various hardware and software disclosed herein are exemplary only and are not intended to limit the scope of the invention in any way.

Consistent with the foregoing, while exemplary embodiments of the invention concern management of content transfer between computing environments, other embodiments of the invention may, more generally, be employed in any application where is desired to implement customized management of the transmission of electronic content. Accordingly, the scope of the invention should not be construed to be limited to the exemplary implementations and embodiments disclosed herein.

With particular attention now to FIG. 1, the communications management system 100 generally includes a communications manager 200 and transmission protocol manager 300 configured to interact with each other. Among other things, the communications manager 200 includes, or is configured to access, various transmission protocols 400 concerning the manner in which transmission of content will be implemented. In this regard, it may be desirable in some cases to generate and disseminate various reports 200A concerning actions implemented by the communications manager 200. As evidenced by the present disclosure, there is virtually no limit to the type, number and content of transmission protocols that can be defined. Likewise, the type and number of actions that can implemented by the communications management system disclosed herein is virtually unlimited.

It should be noted that while the communications manager 200 and transmission protocol manager 300 are illustrated as being discrete elements of communications management system 100, the communications manager 200 and transmission protocol manager 300 may, in other embodiments, collectively comprise a single element. Accordingly, the embodiment presented in FIG. 1 is for illustrative purposes only and is not intended to limit the scope of the invention in any way.

Moreover, the respective, and collective, functionalities afforded by the communications manager 200 and transmission protocol manager 300, as disclosed herein, may be implemented in various way and with various systems and devices. Consistent with the foregoing, any other systems, methods, devices, and/or software effective in implementing some or all of the functionality of communications management system 100 may alternatively be employed, and the scope of the invention should not be construed to be limited to any particular implementation.

As noted above, the actions of the communications manager 200 are guided by transmission protocols 400 that are, exemplarily, created and managed by way of the transmission protocol manager 300. Generally, the transmission protocol manager 300 permits a user to define, or automatically generate in some instances, various transmission protocols 400 for use by the communications manager 200, and/or by other systems and devices, in the implementation of various actions relating to the transmission of particular content. The transmission protocol manager 300 may also be employed to, among other things, check for transmission protocol conflicts, import transmission protocols for use by the communications manager 200, and disseminate transmission protocols to various users and systems. Among other things, this functionality obviates the need for multiple recreations of previously developed transmission protocols 400.

As noted above, one aspect of some embodiments of the invention is a conflict identification function that serves to identify and flag any conflicts between transmission protocols 400 that, for example, pertain to the same content. As an example of such a conflict, one transmission protocol 400 may specify that content to be transmitted to user 1 has a higher priority for transmission than content to be transmitted to user 2, while another transmission protocol 400 may specify the opposite priority.

In some cases, the conflict identification function comprises a part of the transmission protocol manager 300 so that no new transmission protocol may be built or defined that conflicts with one or more existing transmission protocols. The conflict identification function may permit a user to delete one or more conflicting transmission protocol or, where such feature is included in the transmission protocol manager 300, may permit a user to craft a transmission protocol consistent with existing transmission protocols.

Further, transmission protocols may be defined with certain hierarchical references or aspects. By way of example, a system administrator may define certain transmission protocols for handling content on all machines in a particular operating environment. However, within the boundaries defined by such transmission protocols, a user may further define customized transmission protocols specific to that user, so long as such transmission protocols are consistent with the higher level transmission protocols specified by the system administrator.

In connection with the foregoing, it should be noted that in some embodiments of the invention, some or all aspects of the transmission protocols 400 may, instead of being centrally deposited in the communications manager 200, be included within, or otherwise associated with, the content to be transmitted. The actions specified by the applicable transmission protocols 400 could then be implemented by the communications manager 200 with respect to the associated content. As suggested by the foregoing, the inclusion of the transmission protocols 400 in a communications manager 200 is but one exemplary implementation and, more generally, the transmission protocols 400 may be constructed, implemented and/or located in any other way consistent with the functionality disclosed herein.

Further details are now provided concerning exemplary embodiments of transmission protocols 400 such as may be employed by communications manager 200 in the implementation of various actions concerning the transmission of content associated with the environment in connection with which the communications management system 100 is employed. Generally, such transmission protocols 400 may be configured and/or employed in any fashion suitable to facilitate achievement of these ends.

Exemplarily, such transmission protocols 400 embody, or otherwise express or represent, certain relationships between various attributes of the content with which the communications management system 100 is concerned, and various other factors, such as, but not limited to, the available bandwidth of the associated communications medium, or channel, and various actions relating to the transmission of such content over the communications channel. However, the foregoing are only examples of factors that may be considered in the definition of various transmission protocols 400, and any other factors or variables may additionally, or alternatively, be employed to that end as necessary to suit the requirements of a particular application.

II. Aspects of Exemplary Transmission Protocol Configurations

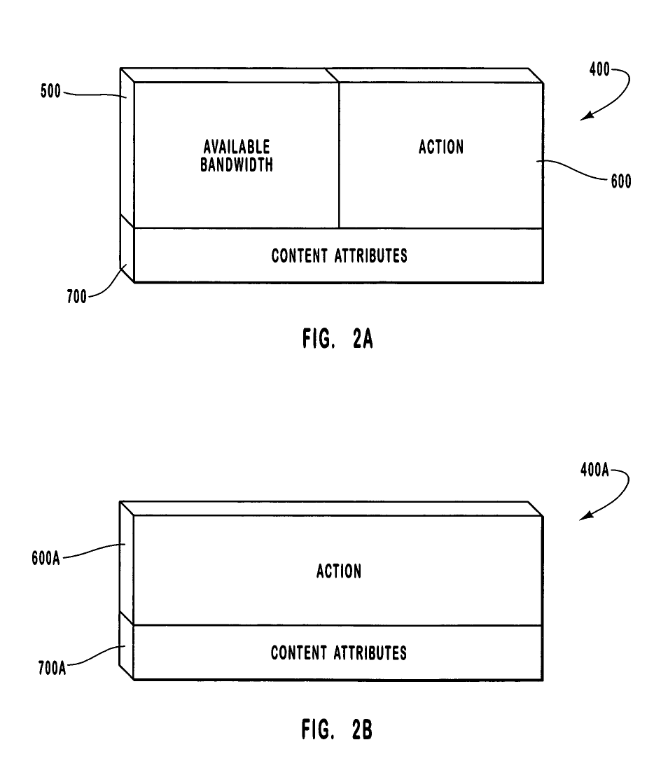

With particular attention now to FIG. 2A, an exemplary embodiment of a transmission protocol 400 is illustrated that defines relationships between and among an available bandwidth 500, one or more actions 600 and various content attributes 700. In general, the exemplary illustrated embodiment of transmission protocol 400 represents a particular relationship which may be expressed in the following form: “If content attributes ‘A’ are present or indicated in the content identified for transmission, and available bandwidth ‘B’ meets certain criteria, then perform action ‘C’ with regard to the content identified for transmission.” This relationship is exemplary only however, and various other relationships may likewise be defined.

By way of example, some relationships may be defined without reference to the available bandwidth of the communications channel. Such a relationship may be expressed, for example, as follows: “If content attributes ‘D’ are present or indicated in the content identified for transmission, then perform action ‘E’ with regard to the content identified for transmission.” This relation is illustrated in FIG. 2B, where the exemplary transmission protocol 400A defines a relation between one or more actions 600A and certain content attributes 700A of the content identified for transmission.

As another example, transmission protocol hierarchies may be established. In particular, one transmission protocol may specify that it takes precedence over one or more other transmission protocols. One aspect of such a hierarchical structure is that it permits the communications management system 100 to internally resolve potential or actual transmission protocol conflicts.

As suggested by the foregoing, any number of different transmission protocols, transmission protocol types, transmission protocol combinations, transmission protocol hierarchies, transmission protocol cross-references, and other transmission protocols and relationships, can be defined that serve to guide the operation of the communications manager 200 with respect to content identified for transmission. Accordingly, the protocols and relationships disclosed herein are exemplary only and are not intended to limit the scope of the invention in any way.

III. Content Attributes

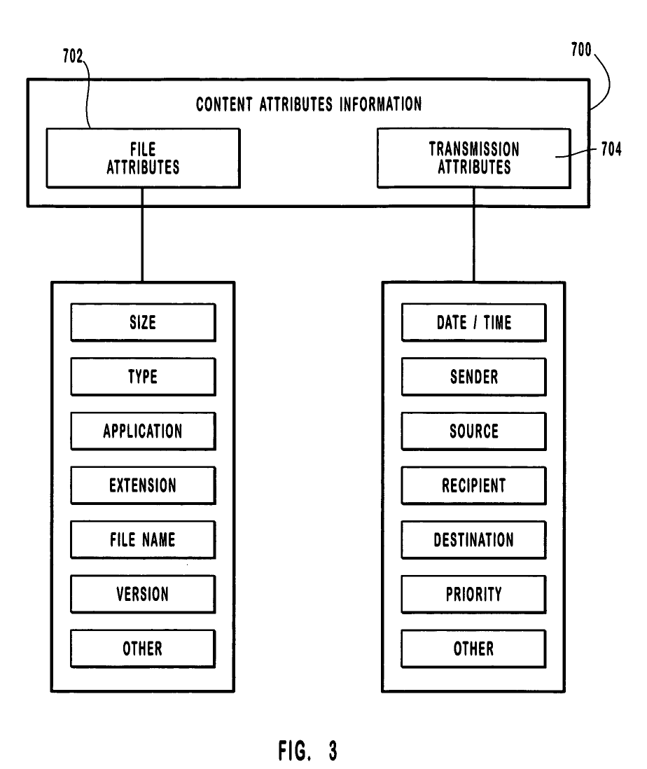

Directing attention now to FIG. 3, further details are provided concerning an exemplary attributes of content in conjunction with which embodiments of the invention may be employed. In general, the illustrated exemplary content attributes information 700 includes file attributes 702 and transmission attributes 704. Note that while the term ‘file’ attributes is used in the foregoing reference, the scope of the invention is not, as noted earlier, limited to any particular type or format of electronic content. Rather, the term ‘file’ is used simply to facilitate the discussion of aspects of the invention.

With reference first to file attributes 702, various types of information may be employed in connection with the operation of the communications management system 100. For example, information such as, but not limited to, the size, type, application, extension, filename, version, and other information, concerning the content identified for transmission may be employed. In this connection, a transmission protocol 400 may provide, for example: “Buffer all content having the ‘jpeg’ extension, and delay transmission of such content until time ‘T’.”

In addition to file attribute information, content attributes 700 such as may be employed in connection with one or more transmission protocols 400 may additionally, or alternatively, include instructions or guidance that relate in some way to the transmission of the content. Examples of such transmission attributes 704 include, but are not limited to, the date/time electronic content was received, the sender, source, recipient and/or destination of particular electronic content, and other information concerning transmission of the content. Yet another example of such transmission attributes 704 information concerns the relative priority assigned, or assignable, to content for transmission.

One example of a transmission protocol 400 that refers to the priority transmission attribute reads: “Assign transmission priority ‘1’ to all content having the extension ‘doc,’ and transmit all priority ‘1’ content before transmitting any other content.” Another example of a transmission protocol 400 that refers to a transmission attribute 704 includes the following: “Transmit all content intended for recipient ‘F’ only after all other queued content has been transmitted.”

Another exemplary transmission protocol focuses on the management of communications bandwidth available to a particular computing environment, with somewhat less emphasis on specific content attributes such as may be present or implicated in other exemplary transmission protocols. Such an exemplary transmission protocol may take the following, or similar, form: “Determine a required bandwidth associated with transmission of the electronic materials identified for transmission and, if the required bandwidth is less than or equal to the available bandwidth of the communications channel, transmit the electronic materials.”

The various aspects of the aforementioned transmission protocol may be implemented in any number of ways. By way of example, the ‘required bandwidth’ may be determined with reference to variables including, but not limited to, the size of the content to be transmitted, the minimum desirable line rate for transmission of such content, and/or the maximum desirable transmission time. Moreover, such a transmission protocol may exemplarily include one or more suitable courses of action in the event that the required bandwidth is determined to be greater than the available bandwidth.

For example, the transmission protocol may provide for time-shifted content transmission by processes such as, but not limited to, buffering of the content until it is determined that sufficient bandwidth is available to support transmission of that content. In this exemplary implementation, the available bandwidth is checked on a periodic, or other, basis, until such time as the available bandwidth is consistent with the required bandwidth. At the same time, relatively smaller files whose required bandwidth is sufficiently close to the available bandwidth, may be transmitted, so that optimal use of whatever bandwidth is available is thereby effected.

Note that because, in at least some embodiments, the ‘required bandwidth’ is exemplarily defined with reference to variables such as desired line speed and the size of the content to be transmitted, bodies of content that are the same size may nonetheless have different respective required bandwidths.

Exemplarily, the functionality specified by the transmission protocol concerning bandwidth management may be implemented in various ways. For example, such functionality may implemented as the primary functionality of a communications management system. Alternatively, such functionality may be implemented as part of a larger communications management system that, in addition to implementing communications management processes and methods on bases such as required and available communications bandwidth, implements such communications management processes and methods on other bases as well. More generally however, embodiments of the invention are not restricted solely to implementations that provide for the use of required and/or available communication bandwidth as bases for communication management actions.

As suggested by the foregoing, one aspect of at least some embodiments of the invention is that such embodiments provide for, among other things, managed use of communications bandwidth associated with a particular computing environment, or environments. Such managed use permits, among other things, efficient and optimal utilization of the communications bandwidth associated with a communications channel.

More generally, and as the discussion of FIGS. 2A, 2B and 3, among others, suggests, one exemplary aspect of embodiments of the invention is that transmission protocols can be defined that facilitate automatic, consistent and systematic processing, by the communications management system 100, of various content identified for transmission. Moreover, by examination of one or more attributes of the content intended for transmission, a determination can readily be made as to aspects such as the nature and/or timing of the action or actions that will be implemented with respect to the transmission of such content.

Yet another aspect of embodiments of the invention is that various communications management actions, respecting various content identified for transmission, can be implemented automatically, in response to the presence or occurrence of certain conditions, states, or other circumstances or information, based upon certain transmission protocols whose elements and relationships may be either predefined or defined contemporaneously with the presence or occurrence of such conditions, states, or other circumstances or information.

Another exemplary aspect of embodiments of the invention is that such communications management actions may be implemented substantially in real time, or on some other temporal basis. The foregoing, and other, functionality associated with embodiments of the invention, contributes to material improvements in the consistency and reliability with which a wide variety of content may be transmitted.

IV. Aspects of Exemplary Communications Management Process Implementations

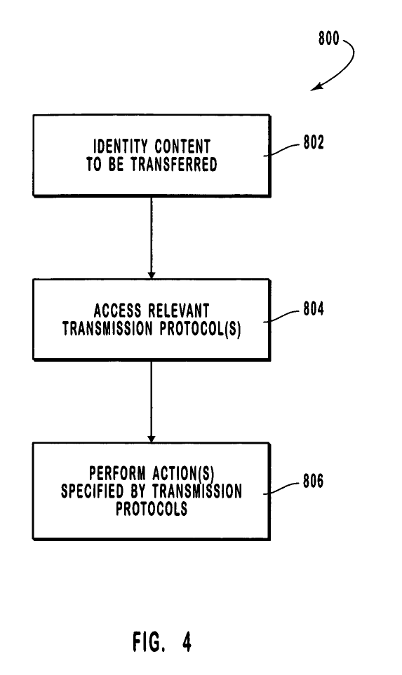

Directing attention now to FIG. 4, various aspects of a process for communications management, designated generally at 800, are indicated. In general, it should be noted that aspects of process 800, as well as aspects of other processes disclosed herein, are exemplarily represented by the relevant figures. Thus, various aspects of the processes disclosed herein may be manipulated as desired, such by combination, refinement, or separation, consistent with the requirements of a particular application and/or operating environment.

As suggested earlier, the communications management process 800 exemplarily comprises three different aspects. More particularly, state 802 of process 800 is initially entered wherein the content that is to be transferred or transmitted is identified. Such content may reside in any of a variety of locations. As an example, such content may reside on a network, a network appliance, a computer that may or may not comprise a portion of a network, a web server, or elsewhere. Moreover, identification of such content may be performed, for example, by examining a buffer containing content, or by examining a content transmission queue, which may reside at the transmitting or receiving device, or elsewhere, that specifies the various materials that are to be transmitted. Any other suitable method for performing such identification may alternatively be employed however.

After such time as the content that is to be transmitted has been identified, the process 800 moves to state 804 where the relevant transmission protocols, if any, are accessed in order to determine what action, if any, should be performed concerning the content thus identified. In at least some implementations, the relevance of any particular transmission protocol is determined by first examining the content attributes information associated with the content to be transmitted, and then searching for any transmission protocols that are implicated by such content attribute information.

Upon identification of the relevant transmission protocol(s), if any, the process 800 moves to state 806 where the action(s) specified by such transmission protocols are implemented by, or at the direction of, the communications manager. In some cases, resort may be had to one or more default transmission protocols, in the event, for example, that the aforementioned search of transmission protocols does not identify any transmission protocols particularly concerning the identified content. In connection with the foregoing, it should be noted that while the term ‘action’ is used herein, it may be the case in some instances that such ‘action,’ whether specified by a transmission protocol or otherwise relevant to the communications manager, in fact, comprises a lack of action with regard to the identified content. Thus, as contemplated herein, an ‘action’ may comprise one or more affirmative acts or, alternatively, may comprise a lack of action.

According to one embodiment of the invention, the transmission of the data or content over the network is performed in response to ambient network traffic conditions. For instance, when a certain amount of data is identified to for transmission, the bandwidth is allocated or throttled as it becomes available based on ambient network traffic conditions. Thus, if relatively little other network traffic is present, the identified content can be transmitted more quickly using the relatively large amount of available bandwidth. On the other hand, if a relatively large amount of other network traffic is present, the identified content is transmitted more slowly using the relatively small amount of available network traffic. Under this model, the amount of available bandwidth is the primary factor that determines when and how quickly the data is transmitted, whereas the amount of required bandwidth is a secondary consideration.

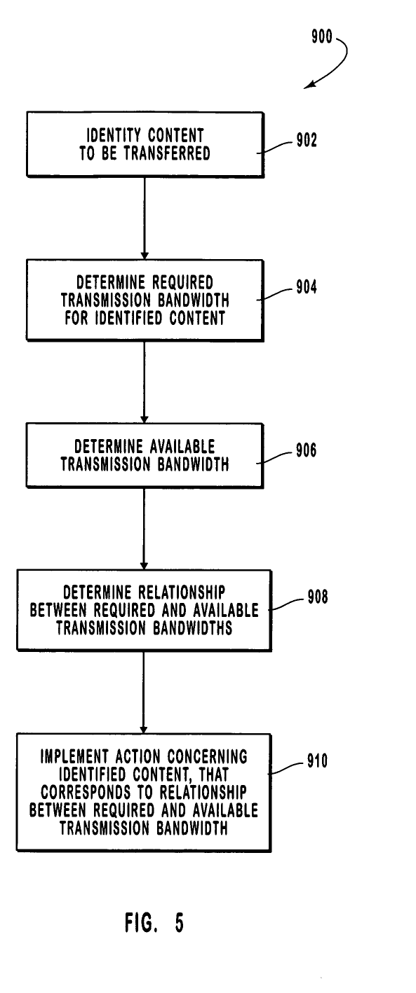

With attention now to FIG. 5, aspects of another exemplary implementation of a process for communications management, designated generally at 900, are indicated. At state 902, the content to be transferred is identified. Exemplarily, such identification is made in the same way as identification of content is made in conjunction with the implementation of process 800.

Upon identification of the content to be transferred, the process 900 moves to state 904 where the required transmission bandwidth associated with such content is determined. Such determination may be made with reference to transmission protocols, content attributes information associated with such content, and/or with reference to variables such as, but not limited to, the size of the content to be transmitted, the minimum desirable line rate for transmission of such content, and/or the maximum desirable transmission time.

After the required bandwidth has been determined, process 900 advances to state 906 where a determination is made as to the bandwidth available in the relevant communications channel. Exemplarily, such a determination may be made by comparing the rated bandwidth, effective bandwidth, or other appropriate parameter, of the communications channel with the portion of such bandwidth employed at the time state 906 is entered. Where a time-shifted transmission is desired, for example, this determination 906 may be delayed to an appropriate point in time.

In any event, determination of the available bandwidth causes the process 900 to move to state 908 where a determination is made as to the relationship between such available bandwidth and the bandwidth required for transmission of the content. In some instances, such determination exemplarily comprises determining whether the available bandwidth exceeds the required bandwidth. In yet other cases, determination of the aforementioned relationship comprises determining whether the available bandwidth falls within a range of permissible bandwidths. The foregoing are exemplary relationships only however, and any other relationship between the required and available bandwidths may be referenced and employed as necessary to suit the requirements of a particular application and/or operating environment. As noted above, the amount of available bandwidth is often the determining factor, since the available bandwidth can be throttled as more or less bandwidth becomes available during the transmission process.

Next, the process 900 enters state 910 where the action, or actions, implicated by the relationship between the required and available bandwidths, are implemented by, or at the direction of, the communications manager. Such actions may be determined with reference to transmission protocols, content attributes information associated with such content, and/or with reference to variables such as, but not limited to, the size of the content to be transmitted, the minimum desirable line rate for transmission of such content, and/or the maximum desirable transmission time.

In the exemplary case where the available transmission bandwidth meets or exceeds the bandwidth requirements associated with the content identified for transmission, the implemented action comprises transmitting the content to its destination. As another example, if the available transmission bandwidth is less than the required transmission bandwidth, transmission of the content is delayed until the available transmission bandwidth is sufficient to support transmission of the content. In some cases, such transmission delay may comprise delaying transmission of the content to an off-peak bandwidth usage time period such as, for example, between midnight and six o'clock in the morning. In many implementations, the amount of available bandwidth is the most pertinent factor, since the available bandwidth can be throttled as more or less bandwidth becomes available. Although a relatively little amount of bandwidth may be available at any given time, this generally only means that the content is transmitted more slowly than would be the case if more bandwidth were available.

It should be noted that the foregoing are exemplary actions that may be implemented in light of certain exemplary relationships such as may be ascertained and/or defined with reference to the available and required bandwidths. More generally, any other action, or actions, may be implemented that correspond in some way with an identified and/or defined relation between the available and required bandwidths.

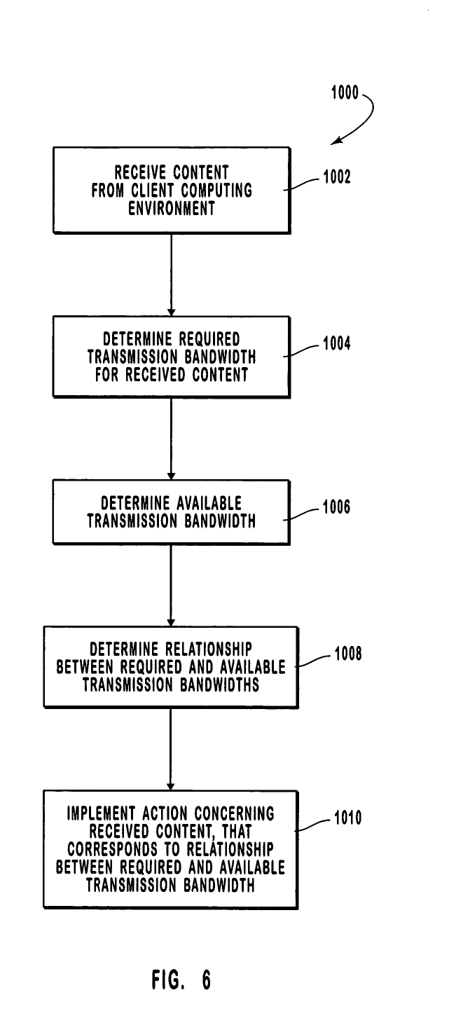

As discussed in further detail below, embodiments of the invention are suitable for implementation in a variety of different operating environments. In one exemplary implementation, an embodiment of the invention is employed in conjunction with a client computing environment configured to upload content to one or more remote devices, such as a web server, or other Internet destination. Aspects of an exemplary process for implementing such functionality are illustrated in FIG. 6, wherein the process is denoted generally at 1000.

More particularly, process 1000 initially enters state 1002 where content for uploading is received, such as by a network appliance or any other suitable device, from one or more devices associated with a client computing environment which may comprise, a single computing device, multiple computing devices, or various other configurations. In another exemplary implementation, the content may initially be uploaded from the client computing environment to a communications management service that, guided by transmission protocols or other appropriate information, takes control of further transmission of the content, such as to a web server or other destination.

In any event, after such content has been received, the process 1000 moves to states 1004 through 1008, generally as described above in connection with process 900. Ultimately, the process 1000 moves to state 1010 where the action, or actions, implicated by the relationship between the required and available bandwidths, are implemented by, or at the direction of, the communications manager. As in the case of at least some other exemplary implementations herein, such actions may be determined with reference to transmission protocols, content attributes information associated with the content to be uploaded, and/or with reference to variables such as, but not limited to, the size of the content to be transmitted, the minimum desirable line rate for transmission of such content, and/or the maximum desirable transmission time.

In the exemplary case where the available transmission bandwidth meets or exceeds the bandwidth requirements associated with the content identified for transmission, the implemented action comprises uploading the content to one or more predetermined web servers. As another example, in the event that the available transmission bandwidth is less than the bandwidth requirements associated with the content identified for transmission, the content is buffered at the appliance, communications management service, or other location, as applicable, until sufficient transmission bandwidth is determined to be available. In many cases, however, the bandwidth is often sufficient, even if relatively little bandwidth is available. As noted above, the available bandwidth can be throttled based on ambient network traffic. When network traffic conditions change, the bandwidth available for the transmission of the content can be increased or decreased as necessary.

More generally however, any other action, or actions, may be implemented that correspond in some way with an identified and/or defined relation between the available and required bandwidths.

V. Aspects of Various Exemplary Operating Environments

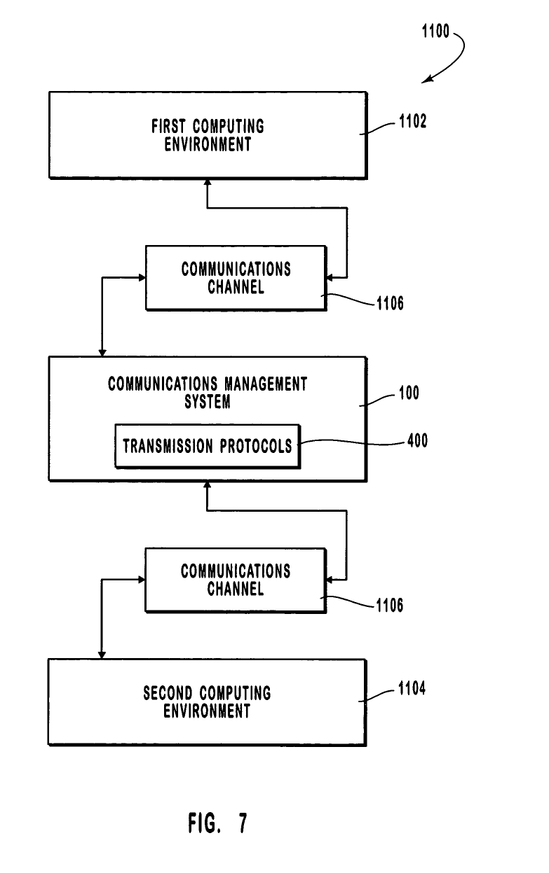

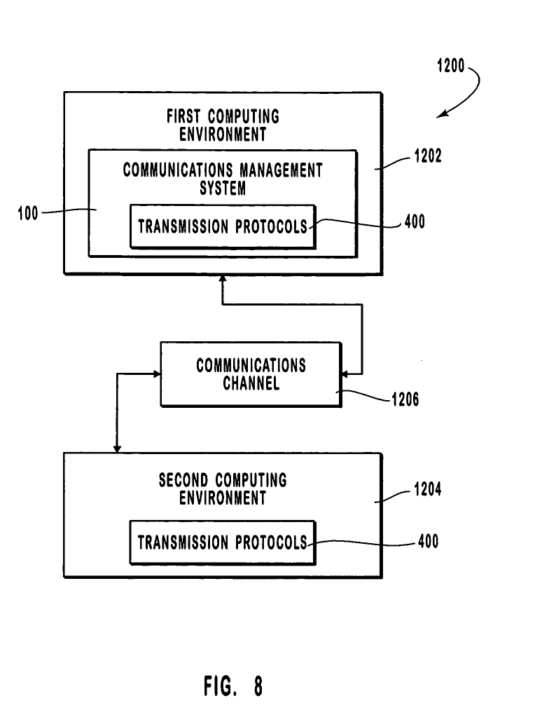

It was noted earlier that embodiments of the invention are suitable for implementation in various operating environments. One such exemplary operating environment is denoted generally at 1100 in FIG. 7. As indicated there, the communications management system 100 serves, generally as disclosed elsewhere herein, to manage communications between a first computing environment 1102 and a second computing environment 1104 by way of one or more communications channels 1106, which may comprise discrete communications channels or, alternatively, portions of the same communications channel. As discussed in further detail below, in connection with FIGS. 8 through 10, aspects of the functionality of the communications management system 100 may be implemented in various ways.

The first computing environment 1102 and the second computing environment 1104 may comprise any system, device, or combination thereof in conjunction with which it is desired to manage associated content transmission, whether such content is transmitted from and/or to such system, device, or combination. Thus, exemplary computing environments include, but are not limited to, a single computer, computer networks such as LANs and WANs that include multiple computing devices, wherein such computer networks may or may not include a network appliance and/or access point. Other exemplary computing environments include web servers and home networks and systems. Moreover, and as noted elsewhere herein, exemplary communication channels in conjunction with which embodiments of the invention may be employed include, but are not limited to, POTS, DSL, cable, and broadband, systems, hardware and software.

As suggested above, embodiments of the invention are suitable for employment in a variety of operating environments and, moreover, the functionality disclosed herein may be implemented by any of a variety of systems, devices, hardware, and/or software. Aspects of another exemplary operating environment, and implementation of the functionality disclosed herein, are illustrated in FIG. 8, where the operating environment is denoted generally at 1200.

As indicated in FIG. 8, the operating environment includes first and second computing environments 1202 and 1204, respectively, configured for communication with each other by way of one or more suitable communication channels 1206. As suggested by the exemplary implementation illustrated in FIG. 8, the communications management system 100 functionality can be implemented substantially within a particular computing environment, the first computing environment 1202 in this case, as may be necessary to suit the requirements of a particular application or use. Such an arrangement stands in contrast with that illustrated in FIG. 7, discussed above, where the communications management system 100 functionality is implemented outside the computing environments between which it is desired to transmit content.

In similar fashion, the transmission protocols 400 may reside at a particular desired computing environment, such as the first computing environment 1202 by way of which the communications management system 100 functionality is implemented. Alternatively, and as further suggested by FIG. 8, the transmission protocols 400 may reside elsewhere, such as at the second computing environment 1204. Such arrangements of the transmission protocols are exemplary only however and, more generally, the transmission protocols 400 may be disposed in any location consistent with implementation of the functionality disclosed herein. By way of example, some embodiments of the invention provide for locating the transmission protocols at the intended recipient of the content to be transferred. In yet other arrangements, each computing environment includes a respective set of transmission protocols.

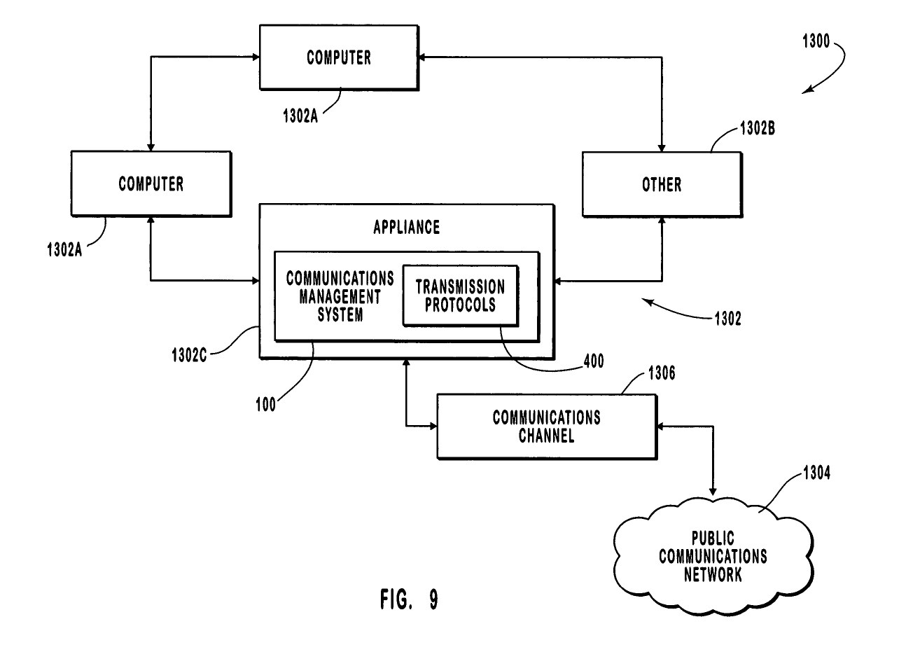

Directing attention now to FIG. 9, details are provided concerning another exemplary operating environment for some embodiments of the invention. In this case, the operating environment, denoted generally at 1300, comprises a client computing environment 1302 configured for communication with a public communications network 1304, such as the Internet for example, by way of a communications channel 1306. Exemplarily, the client computing environment 1302 comprises a network that includes one or more computers 1302A and other systems and devices 1302B, as well as an appliance 1302C. Generally, the appliance 1302C can be any system, device, or combination thereof, capable of implementing one or more aspects of the functionality disclosed herein. Exemplarily, the appliance 1302C comprises a processor, memory, and a communication device, such as a modem, and/or other systems and devices configured to implement communication between the appliance 1302C and other systems and devices remote from the client computing environment 1302.

In the illustrated implementation, the communications management system 100 functionality, as well as the transmission protocols 400, are implemented substantially within the client computing environment 1302, similar to the case of the exemplary arrangement illustrated in FIG. 8. As in the case of at least some other exemplary implementations disclosed herein, the communications management system 100 functionality may be implemented with respect to content desired to be uploaded from the client computing environment 1302 to the public communications network 1304, and/or with respect to content desired to be downloaded from the public communications network 1304 to the client computing environment 1302.

Another aspect of the illustrated implementation is that content desired to be transmitted from the client computing environment 1302 can be passed from one or more of the devices in the client computing environment 1302 to the appliance 1302C. In this way, content desired to be transmitted can be staged at the appliance 1302C for further handling and subsequent transmission.

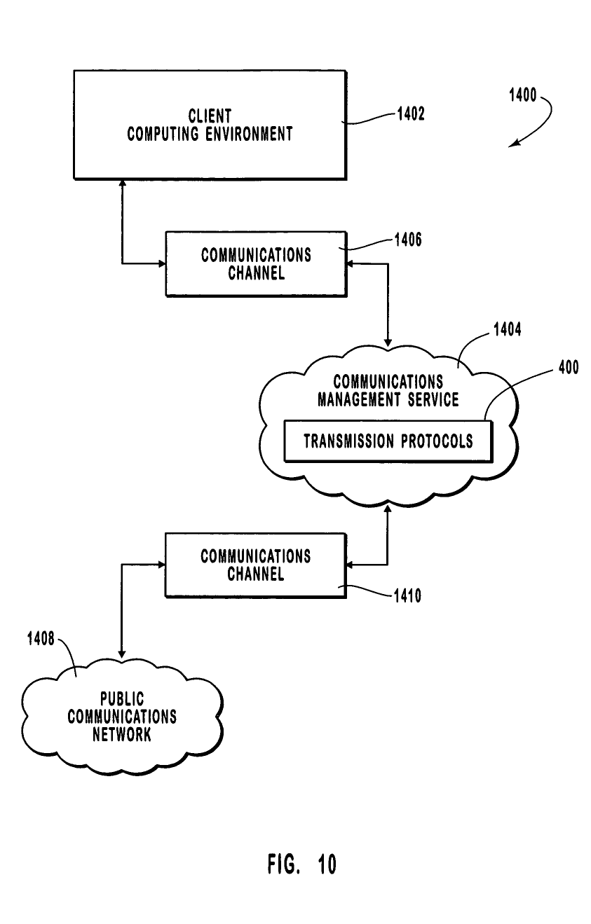

With attention now to FIG. 10, aspects of another exemplary operating environment, and implementation of the functionality disclosed herein, are illustrated. In general, FIG. 10 is concerned with an arrangement where some or all aspects of the functionality disclosed herein are performed as part of a communications management service implemented, for example, on a fee basis that relates to the total bandwidth used by the client computing environment 1402 during a predetermined time period. The associated exemplary operating environment, denoted generally at 1400, includes a client computing environment 1402 configured for communication with the communications management service 1404 by way of a suitable communications channel 1406. The communications management service 1404, in turn, includes the transmission protocols 400 associated with the client computing environment 1402, and is configured to communicate with another computing environment, such as a public communications network 1408, by way of a suitable communications channel 1410.

One aspect of such an arrangement is that the client, or clients, can transmit content to the communications management service 1404 with the assurance that the communications management service 1404, guided by the transmission protocols 400, will manage the subsequent communication or transmission of that content in the desired manner. In similar fashion, the communications management service 1404 may additionally, or alternatively, be employed to manage content whose destination is the client computing environment 1402.

Such management of the content by the communications management service 1404 is, exemplarily, substantially transparent to the client computing environment 1402. In some implementations, provision is made for sending various status messages to the client computing environment 1402 concerning content that the client computing environment 1402 has identified to the communications management service 1404 for transmission. Similar functionality may also be implemented concerning content destined for the client computing environment 1402 from a remote location, such as the public communications network 1408.

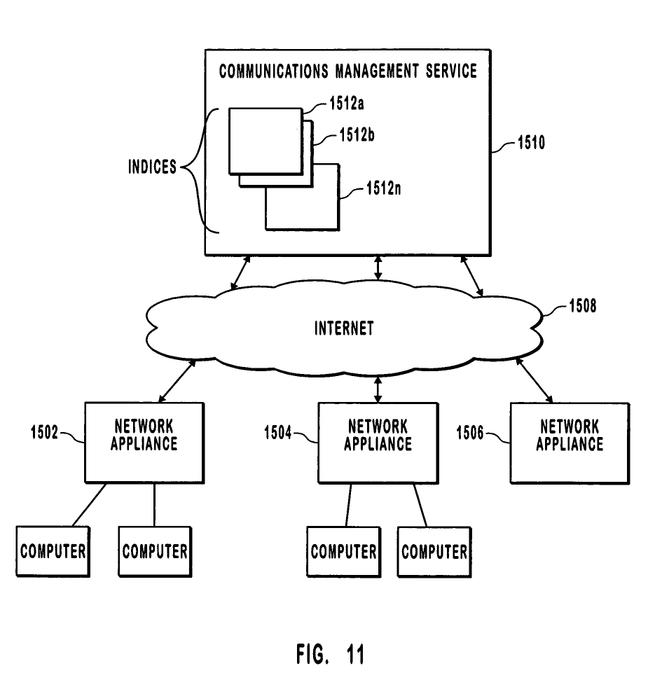

Referring now to FIG. 11, a web-based service can be implemented to coordinate data transmission through a communications management service 1510 to various networks and computing devices. This enables users to engage in data sharing and collaboration and to access data remotely from the users' network appliances. For example, network appliance 1502 may be operated by a user who has content generated by the associated computers. This embodiment of the invention permits this content to be remotely accessible by the user or by authorized third parties who use network appliance 1504 or a remote computer 1506 that is compatible with the methods and systems describe herein.

In this embodiment, rather than storing the full volume of the data of each computer or network appliance on communication management service 1510, the data is primarily stored locally on the individual network appliances 1502 and 1504 or the associated computers. In general, each network appliance 1502 and 1504 operates as a firewall that provides security to the local networks. The communications management service 1510 may be, for example, a web-based service that communicates with network appliances 1502 and 1504 and with remote computer 1506 using the Internet 1508. Because of the existence of the firewall, remote users or remote network appliances can access data associated with, for example, network appliance 1502, only if a connection through the associated firewall is established.

According to this embodiment, the connections through the firewalls are established by the network appliances 1502 and 1504 initiating communication with a trusted intermediary, which, in this example, is communication management service 1510. Open connections established by network appliances 1502 and 1504 allow communications management service 1510 to have access to the network appliances through the corresponding firewalls. One approach to maintaining this communication would be to cause each network appliance to maintain an active connection with communication management service 1510 on an ongoing or permanent basis. However, ongoing or permanent connections with communication management service would consume significant amounts of bandwidth, computing resources, and power, particularly in systems that include a large number of network appliances.

Because the purpose of these connections is to permit the communications management system 1510 and, in turn, authorized remote users or network appliances to gain access to content of a specified network appliance, the connections through the firewall only need to be maintained when there is an interested and authorized user or network appliance that desires access to the content. Thus, the use of bandwidth and other resources can be greatly reduced according to this embodiment of the invention in a process by which each network appliance 1502 and 1504 initiates communication intermittently with communications management service 1510. When the network appliance 1502 or 1504 initiates this communication with communications management service 1510, the communication is quickly discontinued unless it is determined that an interested and authorized remote user or network appliance is seeking to gain access to the particular network appliance. The frequency by which the network appliances initiate this communication is high enough to avoid long delays when an interested and authorize user is waiting to gain access to a network appliance but is also low enough to avoid unnecessarily using significant amounts of bandwidth. While the frequency is not critical to the invention and is selected in view of the foregoing tradeoffs, it may vary between 30 seconds to two minutes according to one implementation of the invention.

A remote user or network appliance (e.g., network appliance 1504) initiates the process of accessing content stored on a specified network appliance (e.g., network appliance 1502) by connecting to communications management service 1510. The remote use or network appliance causes a bit or flag 1522a-n to be set for each of the network appliances that it is authorized to access. For example, if remote computer 1506 contacts service 1510 seeking access to content of network appliance 1502 and if the remote computer 1506 or the user thereof is authorized to access the content of network appliance 1502, the flag corresponding to network appliance 1502 is activated. When network appliance 1502 subsequently initiates communication with communications management service 1510, the presence of the corresponding set flag is noted and the network appliance 1502 is then made available to be accessed by remote computer 1506. The network appliance maintains communication with the communications management service 1510 until such time that all associated flags indicate that no remote user or network appliance is seeking to gain access thereto.

This process usually results in a small delay for the remote user in waiting for the network appliance 1502 to initiate the communication with communications management service 1510. To avoid wasting the time spent waiting for the communication to begin, communication management service 1510 can have indices 1512a-n that index the content of the network appliances, including network appliance 1502. Each index 1512a-n is associated with one of the remote network appliances. The requesting user or network appliance can gain immediate access to the index associated with the network appliance from which content is to be obtained and can begin searching for desired content even if the full connection to the remote network appliance is not yet established. Thus, the productivity of the remote user is maintained and a sense of a seamless connection is maintained.

The periodic initiation of communication by network appliances 1502 and 1504 with communications management service 1510 serve two purposes. First, as already mentioned, this period communication allows the network appliance to communicate with the service so as to ascertain whether an open connection should be maintained. Second, this process serves as a health check to verify that each of network appliance 1502 and service 1510 are operating properly. For instance, if a particular network appliance has not initiated communication for an extended period of time, the communications management service and authorized remote users or network appliances can determine that some problem exists to prevent the network appliance from operating properly.

It is also noted that the embodiments of the invention are not limited to only the few devices and networks depicted in FIG. 11. Rather, numerous LANs, remote computers, hot spots, and other computing devices and applications may be connected to and communicate through service 1510.

As suggested elsewhere herein, embodiments of the communications management systems of the invention may be implemented within a variety of different environments. More particularly, embodiments of the present invention may be implemented with a special purpose or general purpose computer including various computer hardware, as discussed in greater detail below. Embodiments within the scope of the present invention also include computer-readable media for carrying or having computer-executable instructions or electronic content structures stored thereon. Such computer-readable media can be any available media which can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or electronic content structures and which can be accessed by a general purpose or special purpose computer.

When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and content which cause a general purpose computer, special purpose computer, or special purpose local processing device to perform a certain function or group of functions.

Although not required, aspects of the invention may be described in the general context of computer-executable instructions, such as program modules, being executed by computers in network environments. Generally, program modules include routines, programs, objects, components, and content structures that perform particular tasks or implement particular abstract content types. Computer-executable instructions, associated content structures, and program modules represent examples of the program code means for executing steps of the methods disclosed herein. The particular sequence of such executable instructions or associated content structures represent examples of corresponding acts for implementing the functions described in such steps.

Of course, the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a client network. In a distributed computing environment for example, program modules may be located in both local and remote memory storage devices.

The described embodiments are to be considered in all respects only as exemplary and not restrictive. The scope of the invention is, therefore, indicated by the appended claims rather than by the foregoing description. All changes which come within the meaning and range of equivalency of the claims are to be embraced within their scope.

1. A method for managing utilization of a communications channel configured for facilitating the transfer of content between a first computing environment and a second computing environment, the method comprising:
identifying the content to be transferred;
identifying an attribute of the identified content; and
causing an action to be taken concerning the identified content, the action at least partially corresponding to the identified attribute.

2. The method as recited in claim 1, wherein the attribute and the action collectively define at least a portion of a transmission protocol.

3. The method as recited in claim 1, wherein the combination comprising the attribute and the action is user-specified.

4. The method as recited in claim 1, wherein the identified attribute of the content comprises at least one of: a file attribute; and a transmission attribute.

5. The method as recited in claim 1, wherein the identified attribute comprises at least one of the following file attributes: file size; file type; application; filename extension; filename; and, version of the file.

6. The method as recited in claim 1, wherein the identified attribute comprises at least one of the following transmission attributes: desired date of transmission; desired time of transmission; sender; source; recipient; destination; and transmission priority.

7. The method as recited in claim 1, wherein the action taken concerning the identified content is selected from the group consisting of: transmitting the identified content without further delay; and delaying transmission of the content until a predetermined time.

8. The method as recited in claim 1, further comprising determining an available bandwidth of the communications channel, and wherein:
identifying an attribute of the identified content comprises determining the size of the content; and
causing an action to be taken concerning the identified content comprises transmitting the identified content if the size of the content is consistent with the available bandwidth of the communications channel.

9. The method as recited in claim 1, wherein identifying the content to be transferred comprises accessing a content transmission queue.

10. The method as recited in claim 1, wherein identifying the content to be transferred comprises accessing a buffer.

11. The method as recited in claim 1, further comprising determining an available bandwidth of the communications channel, the action taken concerning the identified content further corresponding with the available bandwidth.

12. The method as recited in claim 11, wherein the attribute, action, and available bandwidth collectively define at least a portion of a transmission protocol.

13. The method as recited in claim 1, wherein the transmission protocol is user-defined.

14. A method for managing utilization of a communications channel configured for facilitating the transfer of content between a first computing environment and a second computing environment, the method comprising:
defining a transmission protocol that specifies a relationship between, at least, a content attribute and an action to be taken with respect to content that includes the content attribute;
identifying the content to be transferred;
identifying an attribute of the identified content; and
causing the action specified in the transmission protocol to be taken concerning the identified content, if the identified attribute corresponds to the attribute specified in the transmission protocol.

15. The method as recited in claim 14, wherein definition of the transmission protocol is substantially performed by a user.

16. The method as recited in claim 14, wherein the identified attribute of the content comprises at least one of: a file attribute; and a transmission attribute.

17. The method as recited in claim 14, wherein the identified attribute comprises at least one of the following file attributes: file size; file type; application; filename extension; filename; and, version of the file.

18. The method as recited in claim 14, wherein the identified attribute comprises at least one of the following transmission attributes: desired date of transmission; desired time of transmission; sender; source; recipient; destination; and transmission priority.

19. The method as recited in claim 14, further comprising checking for any conflict between the defined transmission protocol and another transmission protocol.

20. A method for managing utilization of a communications channel configured for facilitating the transfer of content between a first computing environment and a second computing environment, the method comprising:
determining a required transmission bandwidth associated with content identified for transferal;
determining an available transmission bandwidth of the communications channel;
determining a relationship between the available transmission bandwidth and the required transmission bandwidth; and
causing an action to be taken, concerning the identified content, that corresponds to the relationship between the available transmission bandwidth and the required transmission bandwidth.

21. The method as recited in claim 20, further comprising monitoring the available bandwidth until the available bandwidth is substantially the same as the required transmission bandwidth.

22. The method as recited in claim 20, wherein causing an action to be taken concerning the identified content comprises transmitting the content at such time as it is determined that the available bandwidth is sufficient for the required transmission bandwidth.

23. The method as recited in claim 20, wherein the action taken concerning the identified content comprises transmitting the content if the available transmission bandwidth is at least substantially the same as the required transmission bandwidth.

24. The method as recited in claim 20, wherein the action taken concerning the identified content comprises transmitting the content by throttling the amount of available bandwidth based on ambient network traffic conditions.

25. The method as recited in claim 20, wherein the required transmission bandwidth is defined with reference to at least one of: content size; a desired line rate; and, a maximum permissible transmission time.

26. A computer program product for implementing a method for managing utilization of a communications channel configured for facilitating the transfer of content between a first computing environment and a second computing environment, the computer program product comprising:
a computer readable medium carrying computer executable instructions for performing the method, wherein the method comprises:
identifying the content to be transferred;
identifying an attribute of the identified content; and
causing an action to be taken concerning the identified content, the action at least partially corresponding to the identified attribute.

27. The computer program product as recited in claim 26, further comprising determining an available bandwidth of the communications channel, and wherein:
identifying an attribute of the identified content comprises determining the size of the content; and
causing an action to be taken concerning the identified content comprises transmitting the identified content if the size of the content is consistent with the available bandwidth of the communications channel.

28. The computer program product as recited in claim 26, wherein the attribute and the action collectively define at least a portion of a transmission protocol.

29. The computer program product as recited in claim 26, wherein the combination comprising the attribute and the action is user-specified.

30. The computer program product as recited in claim 26, wherein the identified attribute of the content comprises at least one of: a file attribute; and a transmission attribute.

31. The computer program product as recited in claim 26, wherein the identified attribute comprises at least one of the following file attributes: file size; file type; application; filename extension; filename; and, version of the file.

32. The computer program product as recited in claim 26, wherein the identified attribute comprises at least one of the following transmission attributes: desired date of transmission; desired time of transmission; sender; source; recipient; destination; and transmission priority.

33. The computer program product as recited in claim 26, wherein the action taken concerning the identified content is selected from the group consisting of: transmitting the identified content without further delay; and delaying transmission of the content until a predetermined time.

34. The computer program product as recited in claim 26, wherein identifying the content to be transferred comprises accessing a content transmission queue.

35. The computer program product as recited in claim 26, wherein identifying the content to be transferred comprises accessing a buffer.

36. The computer program product as recited in claim 26, further comprising determining an available bandwidth of the communications channel, the action taken concerning the identified content further corresponding with the available bandwidth.

37. The computer program product as recited in claim 26, wherein the attribute, action, and available bandwidth collectively define at least a portion of a transmission protocol.

38. A computer program product for implementing a method for managing utilization of a communications channel configured for facilitating the transfer of content between a first computing environment and a second computing environment, the computer program product comprising:
a computer readable medium carrying computer executable instructions for performing the method, wherein the method comprises:
defining a transmission protocol that specifies a relationship between, at least, a content attribute and an action to be taken with respect to content that includes the content attribute;
identifying the content to be transferred;
identifying an attribute of the identified content; and
causing the action specified in the transmission protocol to be taken concerning the identified content, if the identified attribute corresponds to the attribute specified in the transmission protocol.

39. The computer program product as defined in claim 38, wherein definition of the transmission protocol is substantially performed by a user.

40. The computer program product as defined in claim 38, wherein the identified attribute of the content comprises at least one of: a file attribute; and a transmission attribute.

41. The computer program product as defined in claim 38, wherein the identified attribute comprises at least one of the following file attributes: file size; file type; application; filename extension; filename; and, version of the file.

42. The computer program product as defined in claim 38, wherein the identified attribute comprises at least one of the following transmission attributes: desired date of transmission; desired time of transmission; sender; source; recipient; destination; and transmission priority.

43. The computer program product as defined in claim 38, further comprising checking for any conflict between the defined transmission protocol and another transmission protocol.

44. A method for managing communications between computing devices and networks through a communications management service, the method comprising:
identifying content associated with one or more remote computing devices that is to be made remotely accessible;
providing in the communications management service a flag corresponding to each remote computing device associated with the communications management service, one of the flags being activated when a remote user or application contacts the communications management service to access a specified remote computing device;
periodically receiving communication from a remote computing device;
in response to receiving communication from the remote computing device, determining if the flag corresponding to the remote computing device is activated;
if the flag corresponding to the remote computing device is not activated, discontinuing communication between the remote computing device and the communications management service; and
if the flag corresponding to the remote computing device is activated, maintaining communication between the remote computing device and the communications management service, thereby making the remote computing device accessible to the remote user or application.
